(19) United States
(12) Patent Application Publication
(10) Pub. No.: US 2005/0246180 A1
(43) Pub. Date: Nov. 3, 2005

(54) Audio signal process circuit

(75) Inventor: Shoji Saito, Osaka (JP)

Correspondence Address: OSHA LIANG L.L.P., 1221 MCKINNEY STREET, SUITE 2800, HOUSTON, TX, 77010, US

(73) Assignee: Funai Electric Co., Ltd., Osaka (JP)

(21) Appl. No.: 11/117,097

(22) Filed: Apr. 28, 2005

(30) Foreign Application Priority Data
Apr. 28, 2004 (JP) JP2004-132711

(51) Int. Cl. G10L 19/02

(52) U.S. Cl. 704/500

(57) ABSTRACT

An audio signal process circuit to convert a selected input audio signal into a digital audio signal, and to apply an MPEG encode/decode process to the converted digital audio signal upon recording/playing, includes an audio selecting unit to select one input terminal out of one or more external audio input terminal and a tuner audio input terminal to select an analog audio signal, a gain controlling unit to receive the analog audio signal and to control a gain of the analog audio signal into a predetermined value, an A/D converting unit with a phase inversion function, to apply an analog/digital conversion as well as a phase inversion to the analog audio signal, and an encoding/decoding unit to receive a digital audio signal from the A/D converting unit and to apply the MPEG encode or decode process. The A/D converting unit is constructed by a one-chip integrated circuit.

### BACKGROUND OF THE INVENTION

1. Field of the Invention

The present invention relates to an audio signal process circuit provided to an optical disk recording/playing device for recording/playing information of an optical disk such as DVD (Digital Versatile Disk) or the like, for converting the selected input audio signal into the digital audio signal and then applying an MPEG (Moving Picture Image Coding Experts Group) encoding process to the converted digital audio signal at the time of recording and applying an MPEG decoding process to the converted digital audio signal at the time of playing.

2. Description of the Related Art

FIG. 4 is a block diagram showing a configuration of an audio signal process circuit in the related art. An audio signal process circuit 400 includes an input circuit 48 that contains an analog switch circuit 41 as an audio selecting unit to select one input terminal out of an external audio input terminal A, an external audio input terminal B, and a tuner audio input terminal C to select an analog audio signal from this input terminal, a gain control circuit 42 as a gain controlling unit provided at an input stage to receive the analog audio signal from the analog switch circuit 41 and control a gain of the analog audio signal to a predetermined value, a phase inversion circuit 43 as a phase inverting unit to phase-invert the analog audio signal from the gain control circuit 42, an A/D converter 44 as an A/D converting unit to convert the analog audio signal from the phase inversion circuit 43 into a digital audio signal, and an MPEG encode/decode IC 45 as an encoding/decoding unit to receive the digital audio signal from the A/D converter 44 to apply an MPEG encode process or an MPEG decode process to the signal.

Also, the audio signal process circuit 400 includes an output circuit 49 that contains the MPEG encode/decode IC 45 also contained in the input circuit 48, a D/A converter 46 as a D/A converting unit to convert the decoded digital audio signal fed from the MPEG encode/decode IC 45 into the analog audio signal, a gain control circuit 47 as a gain controlling unit provided at an output stage to control a gain of the analog audio signal fed from the D/A converter 46 to a predetermined value and output the controlled analog audio signal, and an output terminal D and an output terminal E for outputting signals fed from the gain control circuit 47 to an external device.

FIG. 5 is a circuit diagram showing an example of the analog switch circuit 41, the gain control circuit 42, and the phase inversion circuit 43 in FIG. 4 respectively. In FIG. 5, in the analog switch circuit 41, a switch 417 having a fixed contact a, a fixed contact b, a fixed contact c, and a movable contact d for selecting any one of the fixed contacts a, b, c to connect is provided. The fixed contact a is connected to the external audio input terminal A via a coupling electrolytic capacitor 411 and a signal level regulating resistor 414. The fixed contact b is connected to the external audio input terminal B via a coupling electrolytic capacitor 412 and a signal level regulating resistor 415. The fixed contact c is connected to the tuner audio input terminal C via a coupling electrolytic capacitor 413 and a signal level regulating resistor 416.

In the gain control circuit 42, an OP amplifier (operational amplifier) 421, a gain control resistor (bias resistor) 422, and a coupling electrolytic capacitor 423 are provided. V1 denotes a reference voltage that is given to a non-inverting input terminal (+ terminal) of the OP amplifier 421. In this case, the coupling electrolytic capacitor 423 is contained in the gain control circuit 42, but such coupling electrolytic capacitor may be provided to the outside of the gain control circuit 42. In the phase inversion circuit 43, an OP amplifier 431, gain control resistors 432, 433, and a coupling electrolytic capacitor 434 are provided. In this case, the coupling electrolytic capacitor 434 is contained in the phase inversion circuit 43, but such coupling electrolytic capacitor may be provided to the outside of the phase inversion circuit 43.

Meanwhile, in the audio signal process circuit 400 in the related art, as shown in FIG. 5, in the analog switch circuit 41, a level of the audio signal being input into the external audio input terminal A is adjusted by the resistor 414, a level of the audio signal being input into the external audio input terminal B is adjusted by the resistor 415, and a level of the audio signal being input into the tuner audio input terminal C is adjusted by the resistor 416. Therefore, a level of the audio signal being input into the inverting input terminal of the OP amplifier 421 is controlled into a proper level for the OP amplifier 421 and thus loss in the gain control circuit 42 and the phase inversion circuit 43 is reduced. Thus, the performance of the audio signal process circuit 400 is never worsened.

However, in the audio signal process circuit 400 in the related art, since two OP amplifiers are used in total in the gain control circuit 42 and the phase inversion circuit 43, a cost increase is caused correspondingly. Here, an amplifier circuit for simply amplifying the input audio signal and sending out the audio signal can be realized only by one OP amplifier without the gain control circuit 42 and the phase inversion circuit 43, and thus a cost reduction can be attained. In this case, the performance of the audio signal process circuit is worsened.

FIG. 6 is a circuit diagram showing an example of an amplifier circuit when the analog switch circuit and one OP amplifier are used. In FIG. 6, in an analog switch circuit 61, a switch 619 having a fixed contact a, a fixed contact b, a fixed contact c, and a movable contact d for selecting any one of the fixed contacts a, b, c to connect is provided. The fixed contact a is connected to the external audio input terminal A via a coupling electrolytic capacitor 611 and a signal level regulating resistor 614. The fixed contact b is connected to the external audio input terminal B via a coupling electrolytic capacitor 612 and a signal level regulating resistor 615. The fixed contact c is connected to the tuner audio input terminal C via a coupling electrolytic capacitor 613 and a signal level regulating resistor 616.

In the switch 619, the audio signal that is divided by a resistor 617, to which a reference voltage V3 is applied, and the signal level regulating resistor 614 is input into the fixed contact a. The audio signal that is divided by a resistor 618, to which the reference voltage V3 is applied, and the signal level regulating resistor 615 is input into the fixed contact b.

In an amplifier circuit 62, an OP amplifier 621, gain control resistors (bias resistors) 622, 623, 624, 625, coupling electrolytic capacitors 626, 627, and an electrolytic capacitor 628 for stabilizing the reference voltage are provided. V4 denotes a reference voltage that is given to a non-inverting input terminal (+ terminal) of the OP amplifier 621. In this case, the coupling electrolytic capacitors 626, 627 are contained in the amplifier circuit 62, but such coupling electrolytic capacitors may be provided to the outside of the amplifier circuit 62.

In the circuit shown in FIG. 6, since only one OP amplifier is used, a cost reduction can be effected correspondingly. However, because the level (voltage) of the external audio signal fed from the external audio input terminal A is divided by the resistor 614 and the resistor 617, for example, in the analog switch circuit 61 at the preceding stage to the amplifier circuit 62, loss of the external audio signal being input into the amplifier circuit 62 is caused and thus the performance of the amplifier circuit 62 is reduced correspondingly. As a result, the performance of the audio signal process circuit is also worsened. In this event, no problem arises if the external audio signal and the tuner audio signal can be similarly processed not to change the gain of the OP amplifier 621. However, if the input level of the amplifier circuit 62 is set to the level of the tuner audio signal, a distortion of the external audio signal being output from the amplifier circuit 62 is generated when the external audio signal is input into the amplifier circuit 62, for the level of the external audio signal is higher than the level of the tuner audio signal. In this case, the performance of the audio signal process circuit is also worsened.

In the related art in JP-A-9-153812, since the phase inversion circuit is provided independently, it is difficult to effect a cost reduction described as above. Also, the phase inversion circuit is disclosed but the gain control circuit is not disclosed, and thus JP-A-9-153812 is not concerned with the audio signal process circuit in which the analog switch circuit, the gain control circuit, the phase inversion circuit, the A/D converter, and the MPEG encode/decode IC are provided.

In the related art in JP-A-11-331997, since the polarity inversion circuit is provided independently, it is also difficult to effect a cost reduction described as above and in the related art. Also, JP-A-11-331997 is not concerned with the audio signal process circuit in which the analog switch circuit, the gain control circuit, the phase inversion circuit, the A/D converter, and the MPEG encode/decode IC are provided.

### SUMMARY OF THE INVENTION

The present invention has been made to overcome the above problems, and it is an object of the present invention to provide an audio signal process circuit capable of removing the necessity of independent provision of a phase inversion circuit and also effecting a cost reduction.

In order to achieve the above object, according to aspect 1 of the invention, an audio signal process circuit for converting a selected input audio signal into a digital audio signal and then applying an MPEG encode process to the converted digital audio signal upon recording and applying an MPEG decode process to the converted digital audio signal upon playing, which includes an audio selecting unit to select one input terminal out of one external audio input terminal or more and a tuner audio input terminal to select an analog audio signal from the input terminal, a gain controlling unit provided at an input stage to receive the analog audio signal from the audio selecting unit and control a gain of the analog audio signal into a predetermined value, an A/D converting unit with a phase inversion function, for applying an analog/digital conversion as well as a phase inversion to the analog audio signal from the gain controlling unit, and an encoding/decoding unit to receive a digital audio signal from the A/D converting unit and applying an MPEG encode process or an MPEG decode process to the digital audio signal. The A/D converting unit with the phase inversion function is constructed by a one-chip integrated circuit.

According to this configuration, for example, when the external audio input terminal is selected by the audio selecting unit, the audio signal being input from the external audio input terminal is level-controlled by the gain controlling unit whose gain has been controlled, and then the audio signal is converted into the digital signal and also the phase is inverted by the A/D converting unit with the phase inversion function. The digital audio signal whose phase is inverted is subjected to the MPEG encode process upon recording and the MPEG decode process upon playing from the encode/decode unit.

According to this configuration, since the function of the phase inversion circuit is incorporated into the A/D converting unit with the phase inversion function, the similar advantages to the case where the gain control circuit and the phase inversion circuit are separated mutually can be achieved. In particular, the phase inversion circuit as the phase inverting unit that is provided separately in the related art can be deleted since the A/D converting unit with the phase inversion function is constructed by a one-chip integrated circuit. As a result, a cost reduction of the audio signal process circuit can be achieved and also a cost reduction of the substrate can be brought about because a circuit area can also be reduced.

According to aspect 2 of the invention, an audio signal process circuit for converting a selected input audio signal into a digital audio signal and then applying an MPEG encode process to the converted digital audio signal upon recording and applying an MPEG decode process to the converted digital audio signal upon playing, which includes an audio selecting unit to select one input terminal out of one external audio input terminal or more and a tuner audio input terminal to select an analog audio signal from the input terminal, a gain controlling unit provided at an input stage to receive the analog audio signal from the audio selecting unit and control a gain of the analog audio signal into a predetermined value, an A/D converting unit to convert the analog audio signal from the gain controlling unit into a digital audio signal, and an encoding/decoding unit with a phase inversion function, for receiving the digital audio signal from the A/D converting unit, applying a phase inversion to the digital audio signal and applying an MPEG encode process or an MPEG decode process to the phase-inverted digital audio signal. The encoding/decoding unit with the phase inversion function is constructed by a one-chip integrated circuit.

According to this configuration, for example, in the case where the external audio input terminal is selected by the audio selecting unit, the audio signal being input from the external audio input terminal is subjected to the level control from the gain controlling unit whose gain has been controlled, and then the audio signal is converted into the digital audio signal by the A/D converting unit. The phase of the digital audio signal is inverted and also such digital audio signal is subjected to the MPEG encode process upon recording or the MPEG decode process upon playing from the encoding/decoding unit with the phase inversion function.

According to this configuration, since the function of the phase inversion circuit is incorporated into the encoding/decoding unit with the phase inversion function, the similar advantages to the case where the gain control circuit and the phase inversion circuit are separated mutually can be achieved. In particular, the phase inversion circuit as the phase inverting unit that is provided separately in the related art can be deleted since the encoding/decoding unit with the phase inversion function is constructed by the one-chip integrated circuit. As a result, a cost reduction of the audio signal process circuit can be achieved and also a cost reduction of the substrate can be brought about because a circuit area can also be reduced.

According to aspect 3 of the invention, an audio signal process circuit for converting a selected input audio signal into a digital audio signal and then applying an MPEG encode process to the converted digital audio signal upon recording and applying an MPEG decode process to the converted digital audio signal upon playing, which includes an audio selecting unit to select one input terminal out of one external audio input terminal or more and a tuner audio input terminal to select an analog audio signal from the input terminal, a gain controlling unit provided at an input stage to receive the analog audio signal from the audio selecting unit and control a gain of the analog audio signal into a predetermined value, an A/D converting unit to convert the analog audio signal from the gain controlling unit into a digital audio signal, and an encoding/decoding unit applying a predetermined encode process or a predetermined decode process to the digital audio signal from the A/D converting unit. A phase inversion function of inverting a phase of the analog audio signal from the gain controlling unit is added to the A/D converting unit or the encoding/decoding unit.

In this configuration, for example, when the external audio input terminal is selected by the audio selecting unit, the audio signal being input from the external audio input terminal is subjected to the level control from the gain controlling unit whose gain has been controlled. In the case where the phase inversion function is added to the A/D converting unit, the audio signal from the gain controlling unit is converted into the digital signal by the A/D converting unit with the phase inversion function and also the phase is inverted. The digital audio signal whose phase is inverted is subjected to the MPEG encode process upon recording or the MPEG decode process upon playing from the encoding/decoding unit.

In contrast, in the case where the phase inversion function is added to the encoding/decoding unit, the audio signal being input from the external audio input terminal is subjected to the level control from the gain controlling unit whose gain has been controlled, and then such audio signal is converted into the digital signal by the A/D converting unit. The phase of the digital audio signal is inverted and also such digital audio signal is subjected to the MPEG encode process upon recording or the MPEG decode process upon playing from the encoding/decoding unit with the phase inversion function.

According to this configuration, since the function of the phase inversion circuit is incorporated into the A/D converting unit or the encoding/decoding unit, the similar advantages to the case where the gain control circuit and the phase inversion circuit are separated mutually can be achieved. The phase inversion circuit as the phase inverting unit that is provided separately in the related art can be deleted. As a result, a cost reduction of the audio signal process circuit can be achieved.

The invention of aspect 4 is the audio signal process circuit characterized in that the audio signal process circuit of aspect 3, the A/D converting unit to which a phase inversion function of inverting a phase of the analog audio signal from the gain controlling unit is added is realized by an A/D converting unit with a phase inversion function, which applies an analog/digital conversion as well as a phase inversion to the analog audio signal from the gain controlling unit, and the A/D converting unit with the phase inversion function is constructed by a one-chip integrated circuit. Therefore, the phase inversion circuit as the phase inverting unit that is provided separately in the related art can be deleted. As a result, a cost reduction of the audio signal process circuit can be achieved and also a cost reduction of the substrate can be brought about because a circuit area can also be reduced.

The invention of aspect 5 is the audio signal process circuit characterized in that the audio signal process circuit of aspect 3, the encoding/decoding unit to which a phase inversion function of inverting a phase of the analog audio signal from the gain controlling unit is added is realized by an encoding/decoding unit with a phase inversion function, which receives the digital audio signal from the A/D converting unit, applies a phase inversion to the digital audio signal and applies a predetermined encode process or a predetermined decode process to the phase-inverted digital audio signal, and the encoding/decoding unit with the phase inversion function is constructed by a one-chip integrated circuit. Therefore, the similar advantages to the case where the gain control circuit and the phase inversion circuit are separated mutually can be achieved, and also the phase inversion circuit as the phase inverting unit that is provided separately in the related art can be deleted. As a result, a cost reduction of the audio signal process circuit can be achieved and also a cost reduction of the substrate can be brought about because a circuit area can also be reduced.

The invention of aspect 6 is the audio signal process circuit characterized in that the audio signal process circuit of aspect 3, the predetermined encode process is an MPEG encode process, and the predetermined decode process is an MPEG decode process. Therefore, the audio signal that is subjected to the MPEG-process can be recorded and also the audio signal that is subjected to the MPEG-process can be reproduced.

As described above, according to the present invention, there is provided an audio signal process circuit for converting a selected input audio signal into a digital audio signal and then applying an MPEG encode process to the converted digital audio signal upon recording and applying an MPEG decode process to the converted digital audio signal upon playing, which includes an audio selecting unit to select one input terminal out of one external audio input terminal or more and a tuner audio input terminal to select an analog audio signal from the input terminal, a gain controlling unit provided at an input stage to receive the analog audio signal from the audio selecting unit and control a gain of the analog audio signal into a predetermined value, an A/D converting unit with a phase inversion function, for applying an analog/digital conversion as well as a phase inversion to the analog audio signal from the gain controlling unit, and an encoding/decoding unit to receive a digital audio signal from the A/D converting unit and applying an MPEG encode process or an MPEG decode process to the digital audio signal, wherein particularly the A/D converting unit with the phase inversion function is constructed by a one-chip integrated circuit. Therefore, the similar advantages to the case where the gain control circuit and the phase inversion circuit are separated mutually can be achieved, and also the phase inversion circuit as the phase inverting unit that is provided separately in the related art can be deleted. As a result, a cost reduction of the audio signal process circuit can be achieved and also a cost reduction of the substrate can be brought about because a circuit area can also be reduced.

Also, according to the present invention, there is provided an audio signal process circuit for converting a selected input audio signal into a digital audio signal and then applying an MPEG encode process to the converted digital audio signal upon recording and applying an MPEG decode process to the converted digital audio signal upon playing, which includes an audio selecting unit to select one input terminal out of one external audio input terminal or more and a tuner audio input terminal to select an analog audio signal from the input terminal, a gain controlling unit provided at an input stage to receive the analog audio signal from the audio selecting unit and control a gain of the analog audio signal into a predetermined value, an A/D converting unit to convert the analog audio signal from the gain controlling unit into a digital audio signal, and an encoding/decoding unit with a phase inversion function, for receiving the digital audio signal from the A/D converting unit, applying a phase inversion to the digital audio signal and applying an MPEG encode process or an MPEG decode process to the phase-inverted digital audio signal, wherein particularly the encoding/decoding unit with the phase inversion function is constructed by a one-chip integrated circuit. Therefore, the similar advantages to the case where the gain control circuit and the phase inversion circuit are separated mutually can be achieved, and also the phase inversion circuit as the phase inverting unit that is provided separately in the related art can be deleted. As a result, a cost reduction of the audio signal process circuit can be achieved and also a cost reduction of the substrate can be brought about because a circuit area can also be reduced.

Also, according to the present invention, there is provided an audio signal process circuit for converting a selected input audio signal into a digital audio signal and then applying an MPEG encode process to the converted digital audio signal upon recording and applying an MPEG decode process to the converted digital audio signal upon playing, which includes an audio selecting unit to select one input terminal out of one external audio input terminal or more and a tuner audio input terminal to select an analog audio signal from the input terminal, a gain controlling unit provided at an input stage to receive the analog audio signal from the audio selecting unit and control a gain of the analog audio signal into a predetermined value, an A/D converting unit to convert the analog audio signal from the gain controlling unit into a digital audio signal, and an encoding/decoding unit applying a predetermined encode process or a predetermined decode process to the digital audio signal from the A/D converting unit, wherein a phase inversion function of inverting a phase of the analog audio signal from the gain controlling unit is added to the A/D converting unit or the encoding/decoding unit. Therefore, the similar advantages to the case where the gain control circuit and the phase inversion circuit are separated mutually can be achieved, and also the phase inversion circuit as the phase inverting unit that is provided separately in the related art can be deleted. As a result, a cost reduction of the audio signal process circuit can be achieved.

### BRIEF DESCRIPTION OF THE DRAWINGS

FIG. 1 is a block diagram showing a configuration of an audio signal process circuit according to a first embodiment of the present invention;

FIG. 2 is a block diagram showing a configuration of an audio signal process circuit according to a second embodiment of the present invention;

FIG. 3 is a block diagram explaining such an event that a reproduced signal is degraded subtly unless a phase of an audio signal is inverted until the audio signal is input to a MPEG encode/decode IC in FIG. 1 or FIG. 2, by way of reference;

FIG. 4 is a block diagram showing a configuration of an audio signal process circuit in the related art;

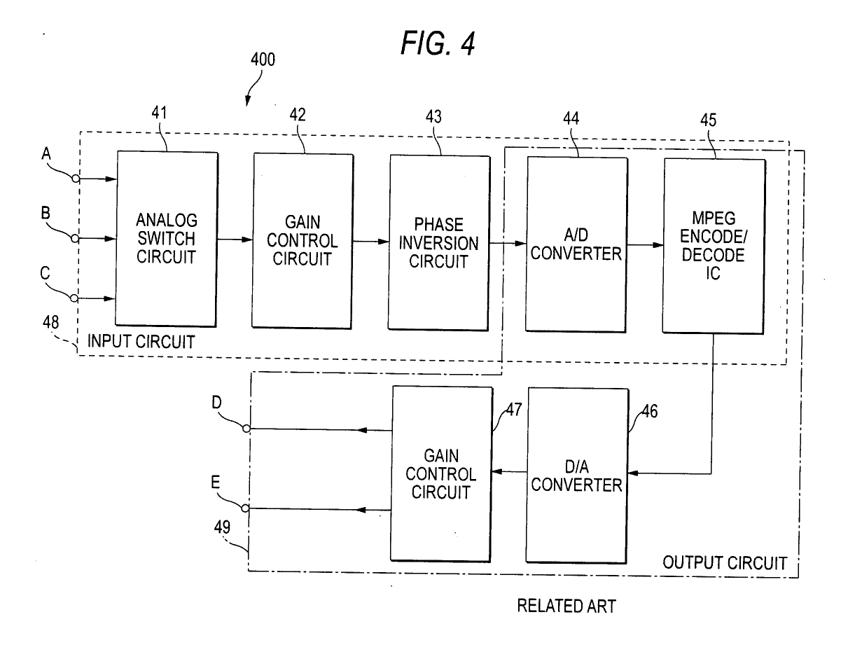

FIG. 5 is a circuit diagram showing an example of an analog switch circuit, a gain control circuit, and a phase inversion circuit in FIG. 4 respectively; and

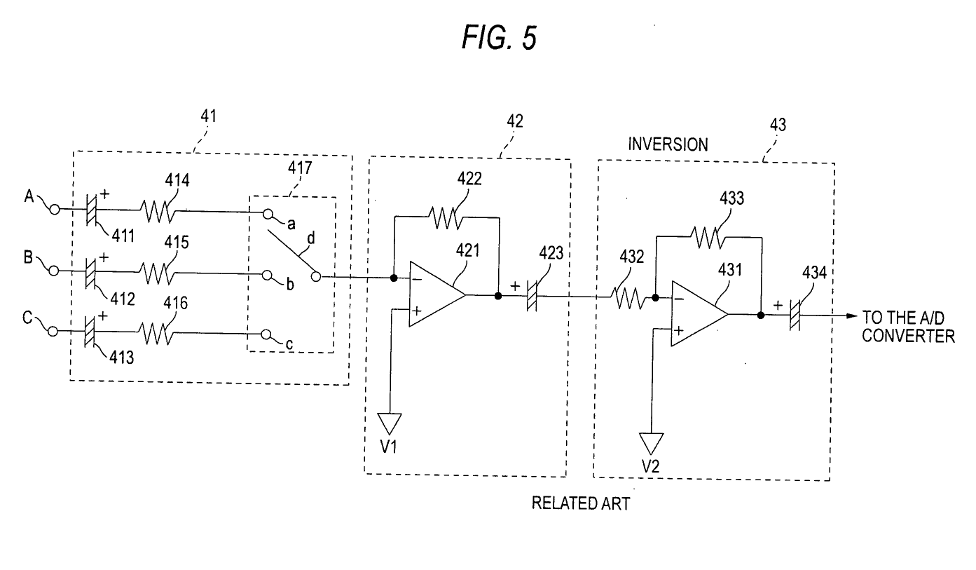

FIG. 6 is a circuit diagram showing an example of an amplifier circuit when the analog switch circuit and one OP amplifier are used.

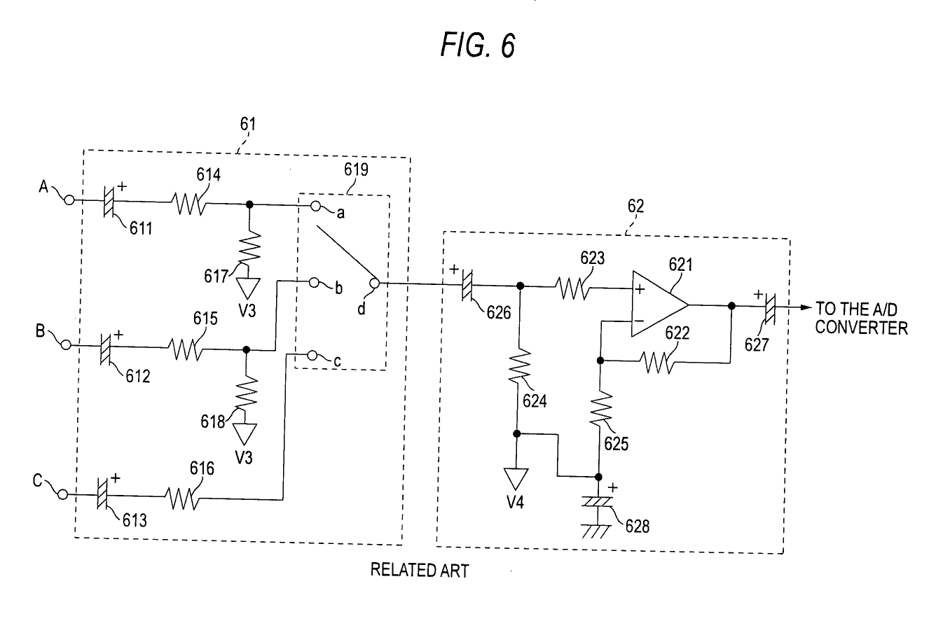

### DETAILED DESCRIPTION OF THE INVENTION

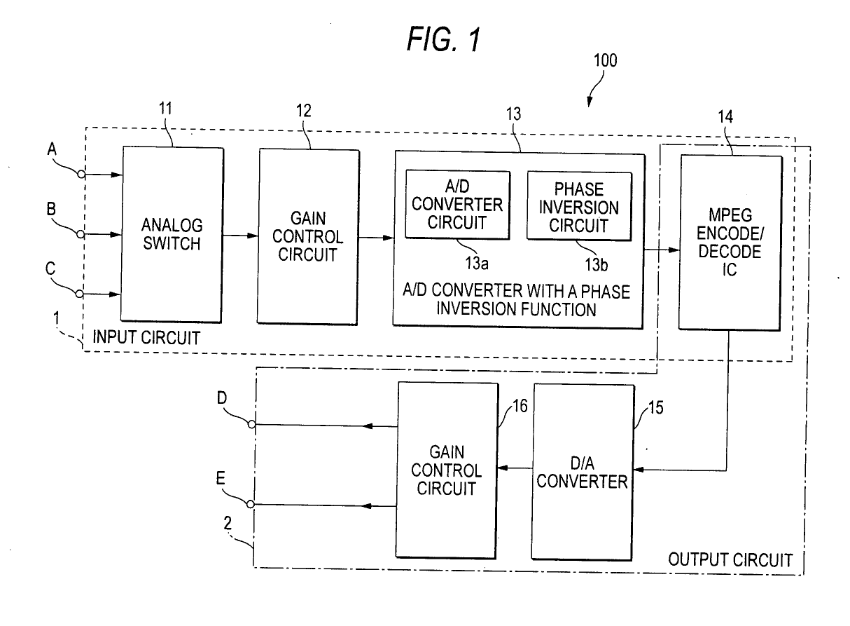

Embodiments of the present invention will be explained with reference to the accompanying drawings hereinafter. FIG. 1 is a block diagram showing a configuration of an audio signal process circuit according to a first embodiment of the present invention.

An audio signal process circuit 100 includes an input circuit 1 that contains an analog switch 11 as an audio selecting unit to select one input terminal out of the external audio input terminal A, the external audio input terminal B, and the tuner audio input terminal C to select the analog audio signal from this input terminal, a gain control circuit 12 as a gain controlling unit provided at an input stage to receive the analog audio signal from the analog switch circuit 11 and control a gain of the analog audio signal to a predetermined value, an A/D converter 13 with a phase inversion function as an A/D converting unit with a phase inversion function for applying the analog/digital conversion and the phase conversion to the analog audio signal fed from the gain control circuit 12, and an MPEG encode/decode IC 14 as an encoding/decoding unit to receive the digital audio signal from the A/D converter 13 to apply the MPEG encode process or the MPEG decode process to the audio signal. The A/D converter 13 with a phase inversion function has an A/D converter circuit 13a to apply the A/D conversion, and a phase inversion circuit 13b to apply the phase inversion. In the A/D converter 13 with a phase inversion function, the phase inversion circuit may be provided at the former stage and the A/D converter circuit may be provided at the latter stage.

Also, the audio signal process circuit 100 includes an output circuit 2 that contains the MPEG encode/decode IC 14 contained in the input circuit 1, a D/A converter 15 as a D/A converting unit to convert the decoded digital audio signal fed from the MPEG encode/decode IC 14 into the analog audio signal, a gain control circuit 16 as a gain controlling unit provided at an output stage to control a gain of the analog audio signal fed from the D/A converter 15 into a predetermined value and output this analog audio signal, and an output terminal D and an output terminal E for outputting the signal fed from the gain control circuit 16 to the outside respectively.

In the audio signal process circuit 100, for example, when the external audio input terminal A connected to an information playing device as an external device is chosen by the analog switch 11, the audio signal being input from the external audio input terminal A is subjected to the level control from the gain control circuit 12 whose gain has been controlled. Then, the audio signal is converted into the digital audio signal by the A/D converter 13 with a phase inversion function, and also the phase is inverted simultaneously. The digital audio signal whose phase is inverted is subjected to either the MPEG encode process upon recording or the MPEG decode process upon playing from the MPEG encode/decode IC 14.

Then, the digital audio data to which the MPEG encode process is applied at the time of recording is fed to a recording process circuit (not shown) and is recorded on the optical disk. In contrast, the digital audio data to which the MPEG decode process is applied at the time of playing is fed to the D/A converter 15, and then is converted into the analog audio signal. Then, a level of this analog audio signal is controlled by the gain control circuit 16, and then such analog audio signal is output from the output terminal D and the output terminal E.

For example, in the case where the output terminal D is a terminal that is connected to an audio input terminal of a television receiver set and the output terminal E is a terminal that is connected to an audio input terminal of an audio amplifier, the audio signal whose level corresponds to an audio input level of the television receiver set is output from the gain control circuit 16 to the output terminal D and also the audio signal whose level corresponds to an audio input level of the audio amplifier is output from the gain control circuit 16 to the output terminal E.

For example, in the case where the tuner audio input terminal connected to a tuner as the external device is chosen by the analog switch 11, the audio signal being input from the tuner audio input terminal C is subjected to the level control from the gain control circuit 12 whose gain has been controlled. Then, the audio signal is converted into the digital audio signal by the A/D converter 13 with a phase inversion function, and also the phase is inverted at the same time. The digital audio signal whose phase is inverted is subjected to either the MPEG encode process upon recording or the MPEG decode process upon playing from the MPEG encode/decode IC 14.

Then, the digital audio data to which the MPEG encode process is applied at the time of recording is fed to the recording process circuit (not shown) and is recorded on the optical disk. In contrast, the digital audio data to which the MPEG decode process is applied at the time of playing is fed to the D/A converter 15, and then is converted into the analog audio signal. Then, the level of this analog audio signal is controlled by the gain control circuit 16, and then the analog audio signal is output from the output terminal D and the output terminal E.

According to the first embodiment, since the function of the phase inversion circuit is incorporated into the A/D converter 13 with a phase inversion function, the similar advantages to the case where the gain control circuit and the phase inversion circuit are separated mutually can be achieved. In particular, the phase inversion circuit that is provided separately in the related art can be deleted since the A/D converter 13 with a phase inversion function is constructed by a one-chip integrated circuit. As a result, a cost reduction of the audio signal process circuit can be achieved and also a cost reduction of the substrate can be brought about because a circuit area can also be reduced.

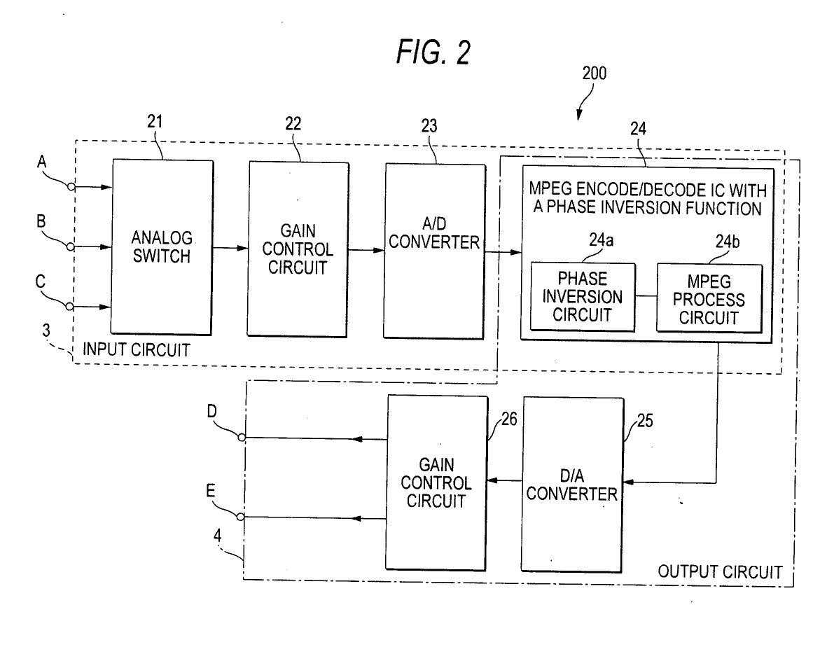

FIG. 2 is a block diagram showing a configuration of an audio signal process circuit according to a second embodiment of the present invention.

This audio signal process circuit 200 includes an input circuit 3 that contains an analog switch 21 as an audio selecting unit to select one input terminal out of the external audio input terminal A, the external audio input terminal B, and the tuner audio input terminal C to select the analog audio signal from this input terminal, a gain control circuit 22 as a gain controlling unit provided at an input stage to receive the analog audio signal from the analog switch circuit 21 and control a gain of the analog audio signal to a predetermined value, an A/D converter 23 as an A/D converting unit to analog/digital convert the analog audio signal fed from the gain control circuit 22, an MPEG encode/decode IC 24 with a phase inversion function as an encoding/decoding unit with a phase inversion function for receiving the digital audio signal from the A/D converter 23 to apply the phase inversion to the digital audio signal and then apply the MPEG encode process or the MPEG decode process to the phase-inverted digital audio signal. The MPEG encode/decode IC 24 with a phase inversion function has a phase inversion circuit 24a and an MPEG process circuit 24b to apply the phase inversion to the digital audio signal and then apply the MPEG encode process or the MPEG decode process to the phase-inverted digital audio signal.

Also, this audio signal process circuit 200 includes an output circuit 4 that contains the MPEG encode/decode IC 24 with a phase inversion function contained in the input circuit 3, a D/A converter 25 as a D/A converting unit to convert the decoded digital audio signal fed from the MPEG encode/decode IC 24 with a phase inversion function into the analog audio signal, a gain control circuit 26 as a gain controlling unit provided at an output stage to control a gain of the analog audio signal fed from the D/A converter 25 into a predetermined value and output this analog audio signal, and the output terminal D and the output terminal E for outputting the signal fed from the gain control circuit 26 to the outside respectively.

In the audio signal process circuit 200, for example, when the external audio input terminal A connected to the information playing device as the external device is selected by the analog switch 21, the audio signal being input from the external audio input terminal A is subjected to the level control from the gain control circuit 22 whose gain has been controlled. Then, the audio signal is converted into the digital signal by the A/D converter 23. The phase of the digital audio signal is inverted by the MPEG encode/decode IC 24 with a phase inversion function, and also such digital audio signal is subjected to either the MPEG encode process upon recording or the MPEG decode process upon playing.

Then, the digital audio data to which the MPEG encode process is applied at the time of recording is fed to the recording process circuit (not shown) and is recorded on the optical disk. In contrast, the digital audio data to which the MPEG decode process is applied at the time of playing is fed to the D/A converter 25, and then is converted into the analog audio signal. Then, the level of this analog audio signal is controlled by the gain control circuit 26, and then such analog audio signal is output from the output terminal D and the output terminal E.

For example, in the case where the output terminal D is a terminal that is connected to an audio input terminal of a television receiver set and the output terminal E is a terminal that is connected to an audio input terminal of an audio amplifier, the audio signal whose level corresponds to an audio input level of the television receiver set is output from the gain control circuit 26 to the output terminal D and also the audio signal whose level corresponds to an audio input level of the audio amplifier is output from the gain control circuit 26 to the output terminal E.

For example, in the case where the tuner audio input terminal connected to a tuner as the external device is selected by the analog switch 21, the audio signal being input from the tuner audio input terminal C is subjected to the level control from the gain control circuit 22 whose gain has been controlled. Then, the audio signal is converted into the digital audio signal by the A/D converter 23 with a phase inversion function, and also the phase is inverted at the same time. The digital audio signal whose phase is inverted is subjected to either the MPEG encode process upon recording or the MPEG decode process upon playing from the MPEG encode/decode IC 24.

Then, the digital audio data to which the MPEG encode process is applied at the time of recording is fed to the recording process circuit (not shown) and is recorded on the optical disk. In contrast, the digital audio data to which the MPEG decode process is applied at the time of playing is fed to the D/A converter 25, and then is converted into the analog audio signal. Then, the level of this analog audio signal is controlled by the gain control circuit 26, and then the analog audio signal is output from the output terminal D and the output terminal E.

According to the second embodiment, since the function of the phase inversion circuit is incorporated into MPEG encode/decode IC 24 with a phase inversion function, the similar advantages to the case where the gain control circuit and the phase inversion circuit are separated mutually can be achieved. In particular, the phase inversion circuit as the phase inverting unit that is provided separately in the related art can be deleted since MPEG encode/decode IC 24 with a phase inversion function is constructed by the one-chip integrated circuit. As a result, a cost reduction of the audio signal process circuit can be achieved and also a cost reduction of the substrate can be brought about because a circuit area can also be reduced.

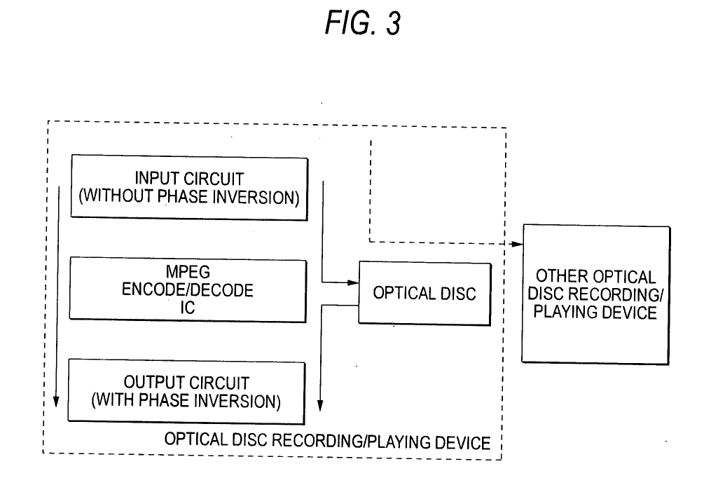

FIG. 3 is a block diagram explaining the event that a reproduced signal is subtly degraded unless the phase of the audio signal is inverted until the signal is input to a MPEG encode/decode IC in FIG. 1 or FIG. 2, by way of reference.

Then, explanation will be made with reference to FIG. 3 hereunder. It is believed that, since the phase inversion function is provided to the D/A converter in the related art, the phase of the audio signal is output correctly from the optical disk recording/playing device by using this phase inversion function. In this event, if the phase is not inverted until the audio signal is input into the MPEG encode/decode IC, the reproduced signal is degraded subtly when the optical disk is played by the other optical disk recording/playing device (the optical disk recording/playing device manufactured by the other maker). As a result, unless the phase of the audio signal is inverted until the audio signal is input into the MPEG encode/decode IC, in some cases the audio signal cannot be used.

As shown in FIG. 3, in the case where the input circuit does not have the phase inversion function and then the audio data are to be recorded on the optical disk via the MPEG encode/decode IC, such audio signal is recorded as the negative signal on the optical disk when the D/A converter tries to invert such audio signal since the audio signal is not actually passed through the D/A converter. Then, when this optical disk is played by the other optical disk recording/playing device, such audio signal is played as the negative signal and thus in some cases the reproduced signal is degraded subtly.

Therefore, sometimes the optical disk cannot be played unless the phase of the audio signal is inverted until the audio signal is input into the MPEG encode/decode IC. As a result, the phase of the audio signal must be inverted until the audio signal is input into the MPEG encode/decode IC.

1. An audio signal process circuit to convert a selected input audio signal into a digital audio signal, and to apply an MPEG encode process to the converted digital audio signal upon recording and to apply an MPEG decode process to the converted digital audio signal upon playing, the audio signal process circuit comprising:
an audio selecting unit to select one input terminal out of one external audio input terminal or more and a tuner audio input terminal to select an analog audio signal from the input terminal;
a gain controlling unit provided at an input stage to receive the analog audio signal from the audio selecting unit and to control a gain of the analog audio signal into a predetermined value;
an A/D converting unit with a phase inversion function, to apply an analog/digital conversion as well as a phase inversion to the analog audio signal from the gain controlling unit; and
an encoding/decoding unit to receive a digital audio signal from the A/D converting unit and to apply the MPEG encode process or the MPEG decode process to the digital audio signal,
wherein the A/D converting unit with the phase inversion function is constructed by a one-chip integrated circuit.

2. An audio signal process circuit to convert a selected input audio signal into a digital audio signal, and to apply an MPEG encode process to the converted digital audio signal upon recording and to apply an MPEG decode process to the converted digital audio signal upon playing, the audio signal process circuit comprising:
an audio selecting unit to select one input terminal out of one external audio input terminal or more and a tuner audio input terminal to select an analog audio signal from the input terminal;
a gain controlling unit provided at an input stage to receive the analog audio signal from the audio selecting unit and to control a gain of the analog audio signal into a predetermined value;
an A/D converting unit to convert the analog audio signal from the gain controlling unit into a digital audio signal; and
an encoding/decoding unit with a phase inversion function, to receive the digital audio signal from the A/D converting unit, to apply a phase inversion to the digital audio signal and to apply the MPEG encode process or the MPEG decode process to the phase-inverted digital audio signal,
wherein the encoding/decoding unit with the phase inversion function is constructed by a one-chip integrated circuit.

3. An audio signal process circuit to convert a selected input audio signal into a digital audio signal, and to apply an MPEG encode process to the converted digital audio signal upon recording and to apply an MPEG decode process to the converted digital audio signal upon playing, comprising:
an audio selecting unit to select one input terminal out of one external audio input terminal or more and a tuner audio input terminal to select an analog audio signal from the input terminal;
a gain controlling unit provided at an input stage to receive the analog audio signal from the audio selecting unit and to control a gain of the analog audio signal into a predetermined value;
an A/D converting unit to convert the analog audio signal from the gain controlling unit into a digital audio signal; and
an encoding/decoding unit to apply a predetermined encode process or a predetermined decode process to the digital audio signal from the A/D converting unit,
wherein a phase inversion function of inverting a phase of the analog audio signal from the gain controlling unit is added to the A/D converting unit or the encoding/decoding unit.

4. The audio signal process circuit according to claim 3, wherein
the A/D converting unit to which the phase inversion function of inverting a phase of the analog audio signal from the gain controlling unit is added is realized by an A/D converting unit with a phase inversion function, which applies an analog/digital conversion as well as a phase inversion to the analog audio signal from the gain controlling unit, and
the A/D converting unit with the phase inversion function is constructed by a one-chip integrated circuit.

5. The audio signal process circuit according to claim 3, wherein
the encoding/decoding unit to which the phase inversion function of inverting a phase of the analog audio signal from the gain controlling unit is added is realized by an encoding/decoding unit with a phase inversion function, which receives the digital audio signal from the A/D converting unit, applies a phase inversion to the digital audio signal and applies a predetermined encode process or a predetermined decode process to the phase-inverted digital audio signal, and
the encoding/decoding unit with the phase inversion function is constructed by a one-chip integrated circuit.

6. The audio signal process circuit according to claim 3, wherein
the predetermined encode process is an MPEG encode process, and
the predetermined decode process is an MPEG decode process.

7. The audio signal process circuit according to claim 5, wherein
the predetermined encode process is an MPEG encode process, and
the predetermined decode process is an MPEG decode process.

8. An audio signal processing method for converting a selected input audio signal into a digital audio signal, and applying an MPEG encode process to the converted digital audio signal upon recording and applying an MPEG decode process to the converted digital audio signal upon playing, the method comprising:
selecting one input terminal out of one external audio input terminal or more and a tuner audio input terminal to select an analog audio signal from the input terminal;
controlling a gain of the inputted analog audio signal into a predetermined value;
analog/digital converting the analog audio signal as well as phase inverting the analog audio signal; and
encoding/decoding an inputted digital audio signal;
wherein the analog/digital converting is performed by a one-chip integrated circuit.
